(19) United States
(12) Patent Application Publication
(10) Pub. No.: US 2016/0262152 A1
(43) Pub. Date: Sep. 8, 2016

(54) TERMINAL AND OPERATING METHOD OF THE SAME, AND RESOURCE ALLOCATING METHOD OF BASE STATION

(71) Applicant: ELECTRONICS AND TELECOMMUNICATIONS RESEARCH NSTITUTE, Daejeon (KR)

(72) Inventors: Sung Jin YOO, Daejeon (KR); Kyu Min KANG, Daejeon (KR); Seung Keun PARK, Daejeon (KR); Jae Cheol PARK, Daejeon (KR); Jung Sun UM, Daejeon (KR); Dong Hun LEE, Daejeon (KR); Hoi Yoon JUNG, Daejeon (KR); Su Na CHOI, Daejeon (KR); Sung Hyun HWANG, Daejeon (KR)

(21) Appl. No.: 15/056,714

(22) Filed: Feb. 29, 2016

(30) Foreign Application Priority Data
Mar. 6, 2015 (KR) 10-2015-0031655

(51) Int. Cl. H04W 72/04; H04W 56/00

(52) U.S. Cl. CPC H04W 72/0446; H04W 56/0015

(57) ABSTRACT

Disclosed is a resource allocating method of a base station, which includes receiving information on an existence signal of another base station or a coexistence frame in a transmission frame of another base station from a terminal, making time synchronization with another base station and frame synchronization with the coexistence frame of another base station coincide with each other, and allocating a signal transmission frame so as not to overlap the signal transmission frame in the transmission frame of another base station.

### CROSS-REFERENCE TO RELATED APPLICATIONS

This application claims priority to and the benefit of Korean Patent Application No. 10-2015-0031655 filed in the Korean Intellectual Property Office on Mar. 6, 2015, the entire contents of which are incorporated herein by reference.

### TECHNICAL FIELD

The present invention relates to a terminal and an operating method of the same, and a resource allocating method of a base station.

### BACKGROUND ART

In an unlicensed band, systems operated by various apparatuses and various operators may use the same frequency band unlike a licensed band. When various apparatuses perform communication by using the same frequency in a contiguous area, a collision occurs, and as a result, system performance may deteriorate. In order to prevent the deterioration of the system performance, a communication system using the unlicensed band has a scheme for coexistence for each communication system.

In the case of a wireless LAN which is a representative communication system using the unlicensed band, a collision between the wireless LANs is reduced by using a carrier sense multiple access/collision avoid (CSMA/CA) scheme. However, in general, in the case of a mobile communication system such as LTE that performs communication by using the licensed band, a collision between apparatuses managed by the same mobile communication operator is prevented through an OFDMA radio resource allocating scheme, but a collision or interference with an apparatus managed by other mobile communication operator is not particularly considered.

### SUMMARY OF THE INVENTION

The present invention has been made in an effort to provide a terminal and an operating method of the same, and a resource allocating method of a base station which can remove a collision and/or interference by multiple base stations in an unlicensed band.

The technical objects of the present invention are not limited to the aforementioned technical objects, and other technical objects, which are not mentioned above, will be apparently appreciated to a person having ordinary skill in the art from the following description.

An exemplary embodiment of the present invention provides a resource allocating method of a base station, including: receiving information on an existence signal of another base station or a coexistence frame in a transmission frame of another base station from a terminal, making time synchronization with another base station and frame synchronization with the coexistence frame of another base station coincide with each other, and allocating a signal transmission frame so as not to overlap the signal transmission frame in the transmission frame of another base station.

The existence signal may be generated by using a Zadoff-Chu sequence.

In the receiving of the information on the existence signal of the another base station or the coexistence frame in the transmission frame of the another base station from the terminal, the existence signal may be received from the terminal through a common frequency band.

The transmission frame may include the coexistence frame and a plurality of signal transmission frames.

In the allocating of the signal transmission frame so as not to overlap with the signal transmission frame in the transmission frame of the another base station, the signal transmission frame may be allocated to the transmission frame after the signal transmission frame of the another base station.

The transmission frame may further include a protection frame defined in the transmission frame after the signal transmission frame of the another base station.

In the allocating of the signal transmission frame so as not to overlap with the signal transmission frame in the transmission frame of the another base station, the signal transmission frame may be allocated to the signal transmission frame of the another base station and the transmission frame after the protection frame.

Another exemplary embodiment of the present invention provides a terminal including: a receiving unit receiving a first existence signal from a first base station through a common frequency band; and a transmitting unit transferring the first existence signal to a second base station through the common frequency band.

The first existence signal may be generated by using a Zadoff-Chu sequence.

The receiving unit may receive a second existence signal from the second base station through the common frequency band.

The terminal may further include a determination unit determining whether the first base station exists by using the first existence signal and determining whether the second base station exists by using the second existence signal.

The terminal may further include an analysis unit determining a first coexistence frame by analyzing the first existence signal and determining a second coexistence frame by analyzing the second existence signal.

The transmitting unit may transfer information on the first coexistence frame to the second base station.

The first base station and the second base station may be operated by different mobile communication operators.

Yet another exemplary embodiment of the present invention provides an operating method of a terminal, including: a receiving unit receiving a first existence signal from a first base station through a common frequency band; and transferring the first existence signal to a second base station through the common frequency band.

The first existence signal may be generated by using a Zadoff-Chu sequence.

The operating method may further include receiving a second existence signal from the second base station; and determining a first coexistence frame by analyzing the first existence signal and determining a second coexistence frame by analyzing the second existence signal.

The operating method may further include transferring information on the first coexistence frame to the second base station.

According to exemplary embodiments of the present invention, a terminal and an operating method thereof, and a resource allocating method of a base station can remove a collision and/or interference by multiple base stations in an unlicensed band.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram for describing an interference situation of a mobile communication system in an unlicensed band according to an exemplary embodiment of the present invention.

FIG. 2 is a block diagram illustrating a terminal according to an exemplary embodiment of the present invention.

FIGS. 3A to 3C and 4 are diagrams for describing an operation of a terminal according to an exemplary embodiment of the present invention.

FIG. 5 is a diagram for describing an operation of a terminal according to another exemplary embodiment of the present invention.

FIG. 6 is a flowchart illustrating an operating method of a terminal according to an exemplary embodiment of the present invention.

FIG. 7 is a flowchart illustrating a resource allocating method of a base station according to an exemplary embodiment of the present invention.

FIG. 8 is a diagram for describing a resource allocating method of a base station according to an exemplary embodiment of the present invention.

FIG. 9 is a diagram for describing a resource allocating method of a base station according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the exemplary drawings. When reference numerals refer to components of each drawing, it is noted that although the same components are illustrated in different drawings, the same components are designated by the same reference numerals as possible. In describing the exemplary embodiments of the present invention, when it is determined that the detailed description of the known components and functions related to the present invention may obscure understanding of the exemplary embodiments of the present invention, the detailed description thereof will be omitted.

Terms such as first, second, A, B, (a), (b), and the like may be used in describing the components of the exemplary embodiments of the present invention. The terms are only used to distinguish a component from another component, but nature or an order of the component is not limited by the terms. Further, if it is not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as ideal or excessively formal meanings unless clearly defined in the present application.

Hereinafter, a ‘terminal’ may be referred to as a mobile station (MSuser equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms.

Various exemplary embodiments of the terminal may include a cellular phone, a smart phone having a wireless communication function, a personal digital assistant (PDA) having the wireless communication function, a wireless modem, a portable computer having the wireless communication function, a photographing device such as a digital camera having the wireless communication function, a gaming device having the wireless communication function, music storing and playing home appliances having the wireless communication function, Internet home appliances in which wireless Internet access and browsing are available and portable units or terminals having integrated combinations of the functions, but are not limited thereto.

Hereinafter, a ‘base station’ generally represents a fixed or movable point which communicates with the terminal and may be terms generally designated as a base station, a node-B, an eNode-B, a base transceiver system (BTS), an access point, a relay, and the like.

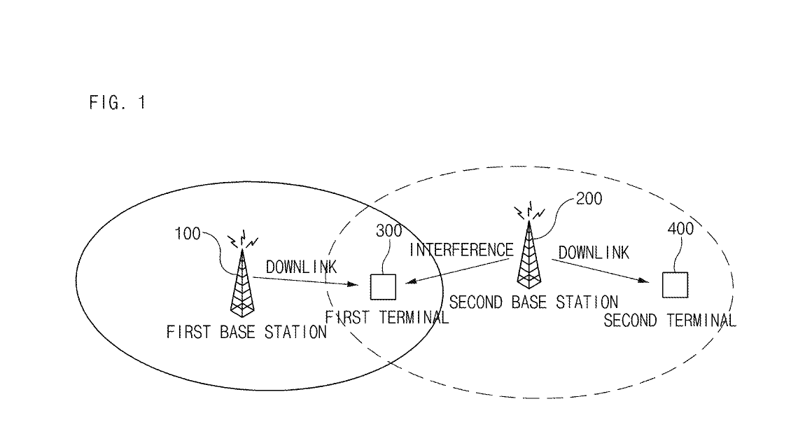

FIG. 1 is a diagram for describing an interference situation of a mobile communication system in an unlicensed band according to an exemplary embodiment of the present invention.

Referring to FIG. 1, cell coverages of a first base station 100 and a second base station 200 may overlap with each other. The first base station 100 and the second base station 200 may be operated by different mobile communication operators. For example, the mobile communication operator (for example, SKT) of the first base station 100 and the mobile communication operator (for example, KT) of the second base station 200 may be different from each other.

A first terminal 300 may be positioned in an area where the cell coverage of the first base station 100 and the cell coverage of the second base station 200 overlap with each other. That is, the first terminal 300 may be positioned in an area where a service area of the first base station 100 and a service area of the second base station 200 overlap with each other. For example, when the first terminal 300 is a terminal that subscribes in a mobile communication service through the first base station 100, communication between the first terminal 300 and the first base station 100 may be interfered by the second base station 200. Similarly, when the first terminal 300 is a terminal that subscribes in the mobile communication service through the second base station 200, communication between the first terminal 300 and the second base station 200 may be interfered by the first base station 100. The second terminal 400 may be a terminal that communicates with the second base station 200.

Hereinafter, the interference situation will be described assuming that the first terminal 300 is the terminal that subscribes in the mobile communication service through the first base station 100. When the interference occurs as described above, it may be difficult for the first terminal 300 to normally receive a signal from the first base station 100.

The first terminal 300 according to the exemplary embodiment of the present invention transfers information on an existence signal of the first base station 100 or a coexistence frame in a transmission frame of the first base station 100 to the second base station 200 to allow the second base station 200 to recognize the first base station 100. The second base station 200 that recognizes the existence of the first base station 100 may allocate the signal transmission frame so as not to overlap with the signal transmission frame of the first base station 100.

Hereinafter, first, the first terminal 300 will be described and thereafter, a resource allocating method of the second base station 200 will be described.

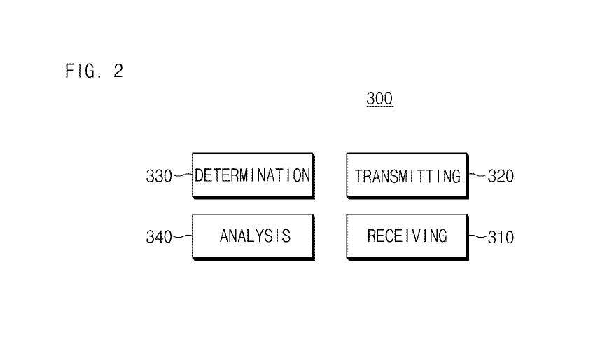

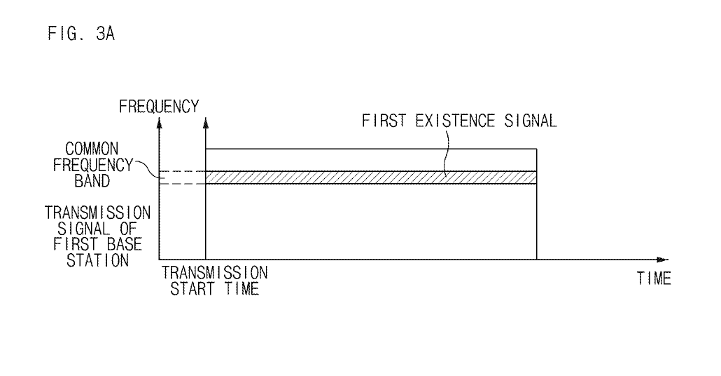

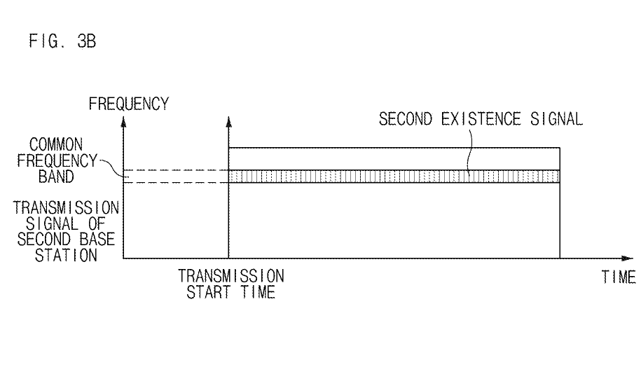

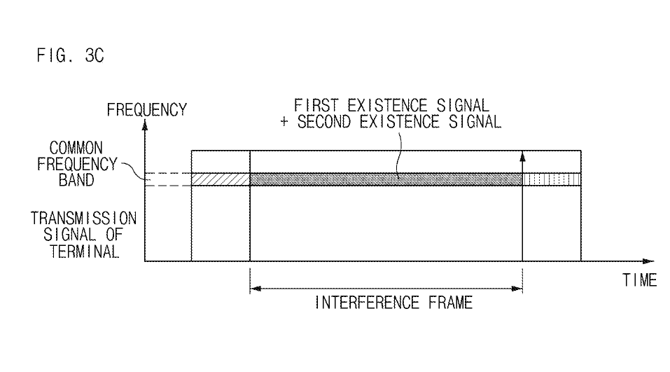

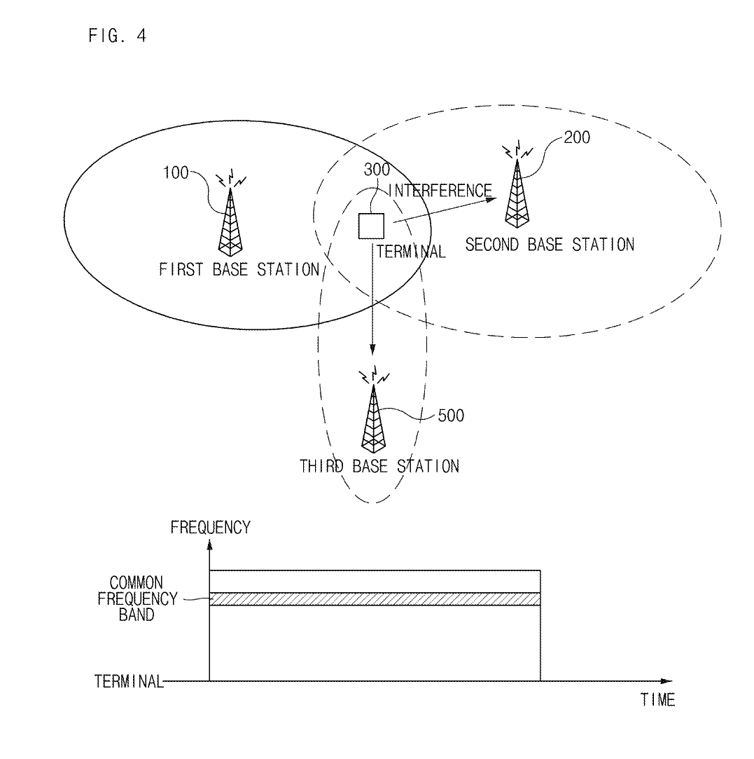

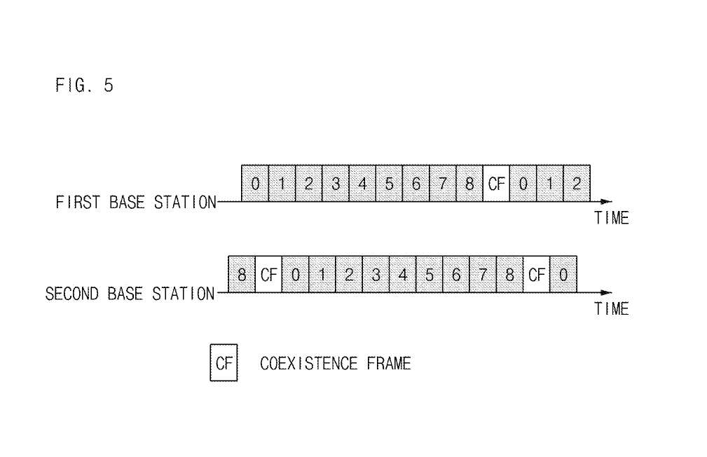

FIG. 2 is a block diagram illustrating a terminal according to an exemplary embodiment of the present invention. FIGS. 3A to 3C and FIG. 4 are diagrams for describing an operation of a terminal according to an exemplary embodiment of the present invention. FIG. 5 is a diagram for describing an operation of a terminal according to another exemplary embodiment of the present invention.

Referring to FIG. 2, the terminal 300 according to the exemplary embodiment of the present invention may include a receiving unit 310, a transmitting unit 320, a determination unit 330, and an analysis unit 340.

Referring to FIGS. 2 and 3A, the receiving unit 310 may receive a first existence signal from the first base station 100. For example, the first existence signal may include information on whether the first base station 100 exists and be generated by using a Zadoff-Chu sequence. The receiving unit 310 may receive the first existence signal from the first base station 100 through a common frequency band. The common frequency band may be set in a predetermined frequency area of an unlicensed band.

Referring to FIGS. 2 and 3B, the receiving unit 310 may receive a second existence signal from the second base station 200 through the common frequency band. For example, the second existence signal may include information on whether the second base station 200 exists and be generated by using the Zadoff-Chu sequence.

Referring to FIGS. 2 and 4, the transmitting unit 320 may transfer the first existence signal to the second base station 200 and/or a third base station 500. The transmitting unit 320 may transfer the first existence signal to the second base station 200 through the common frequency band.

It is illustrated that the receiving unit 310 and the transmitting unit 320 are independently configured in FIG. 2, but the present invention is not limited thereto and the receiving unit 310 and the transmitting unit 320 may be implemented as one communication module.

Referring to FIGS. 2 and 3C, the determination unit 330 may determine whether the first base station 100 exists by using the first existence signal. In addition, the determination unit 330 may determine whether the second base station 200 exists by using the second existence signal. The determination unit 330 determines whether the first base station 100 exists and whether the second base station 200 exists to recognize the interference situation.

As described above, when the interference situation is recognized, the transmitting unit 320 may transfer the first existence signal of the first base station 100 to the second base station 200 and/or the third base station 500.

Referring to FIGS. 2 and 5, the analysis unit 340 analyzes the first existence signal to determine a first coexistence frame (CF). The analysis unit 340 analyzes the second existence signal to determine a second coexistence frame. For example, the first coexistence frame may mean a frame where the signal is not transmitted in the transmission frame of the first base station 100 and the second coexistence frame may mean a frame where the signal is not transmitted in the transmission frame of the second base station 100.

The transmitting unit 320 may transfer information on the first coexistence frame determined through the analysis unit 340 to the second base station 200. The transmitting unit 320 may transfer information on the second coexistence frame determined through the analysis unit 340 to the first base station 100.

As described above, when the interference situation is recognized, the transmitting unit 320 determines the first coexistence frame of the first base station 100 to transfer information on the first coexistence signal to the second base station 200.

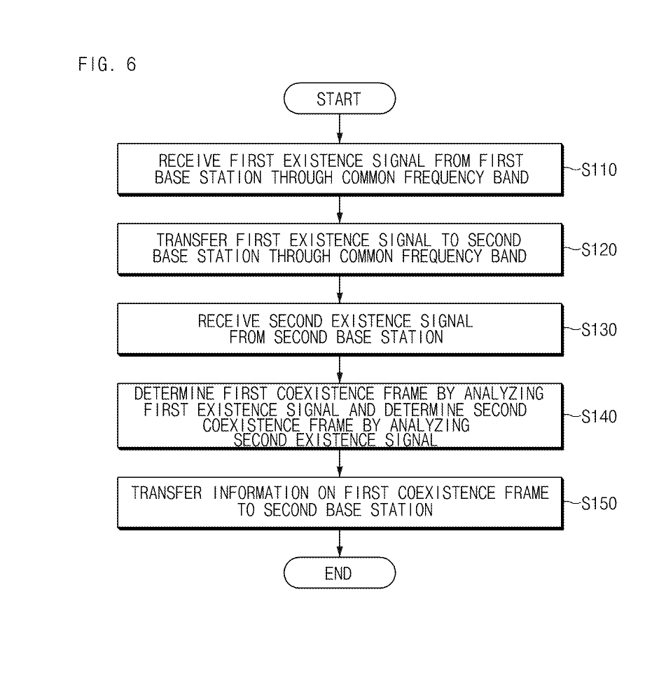

FIG. 6 is a flowchart illustrating an operating method of a terminal according to an exemplary embodiment of the present invention.

Referring to FIG. 6, the operating method of the terminal according to the exemplary embodiment of the present invention may include receiving a first existence signal from a first base station through a common frequency band (S110), transferring the first existence signal to a second base station through the common frequency band (S120), receiving a second existence signal from the second base station (S130), determining a first coexistence frame by analyzing the first existence signal and determining a second coexistence frame by analyzing the second existence signal (S140), and transferring information on the first coexistence frame to the second base station (S150).

In FIG. 6, it is illustrated that the operating method of the terminal according to the exemplary embodiment of the present invention includes steps S110 to S150, but according to the exemplary embodiment, the operating method may be implemented, which includes only steps S110 and S120.

Hereinafter, steps S110 to S150 described above will be described in more detail with reference to FIG. 2.

A receiving unit 310 of a terminal 300 may receive the first existence signal from the first base station 100 through the common frequency band (S110). A transmitting unit 320 of the terminal 300 may transfer the first existence signal to the second base station 200 through the common frequency band (S120).

In addition, the receiving unit 310 may receive a second existence signal from the second base station 200 through the common frequency band (S130). Step S130 may be performed simultaneously with step S120 or earlier than step S120. An analysis unit 340 of the terminal 300 may determine the first coexistence frame by analyzing the first existence signal and determine the second coexistence frame by analyzing the second existence signal (S140). The transmitting unit 320 of the terminal 300 may transfer information on the first coexistence frame to the second base station 200 (S150).

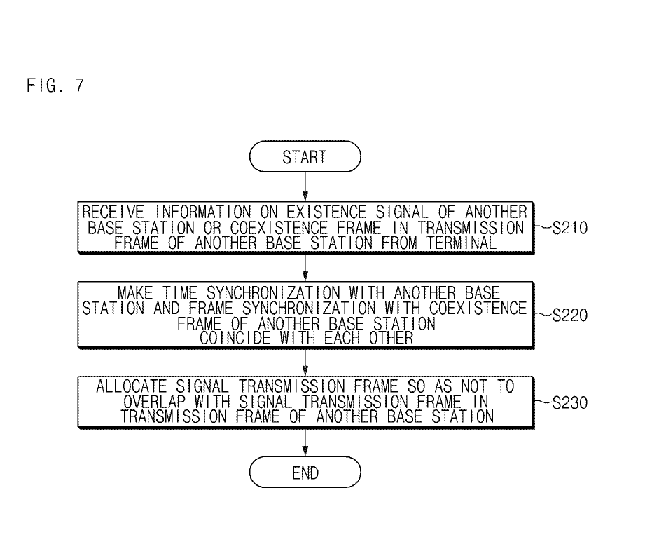

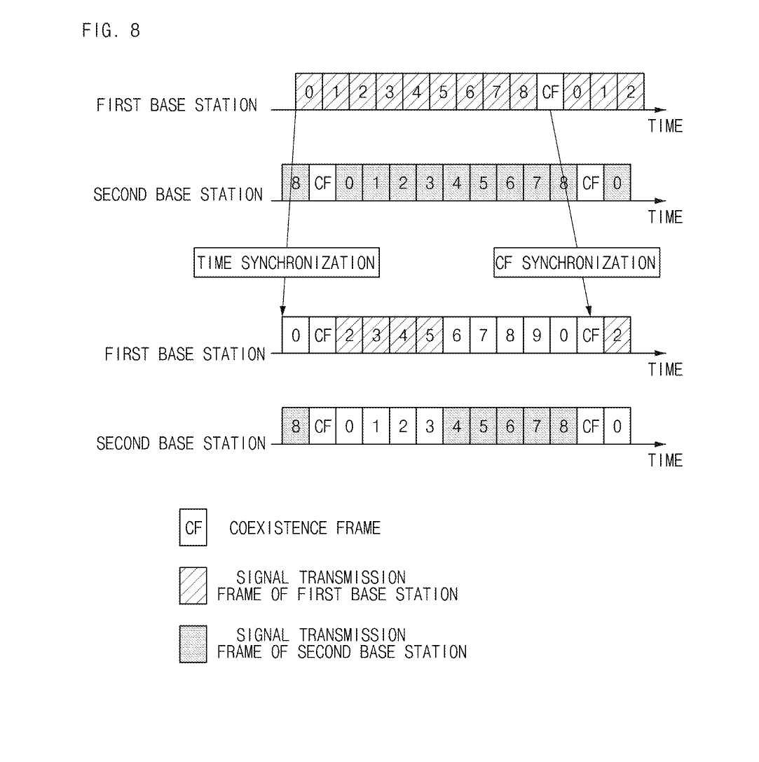

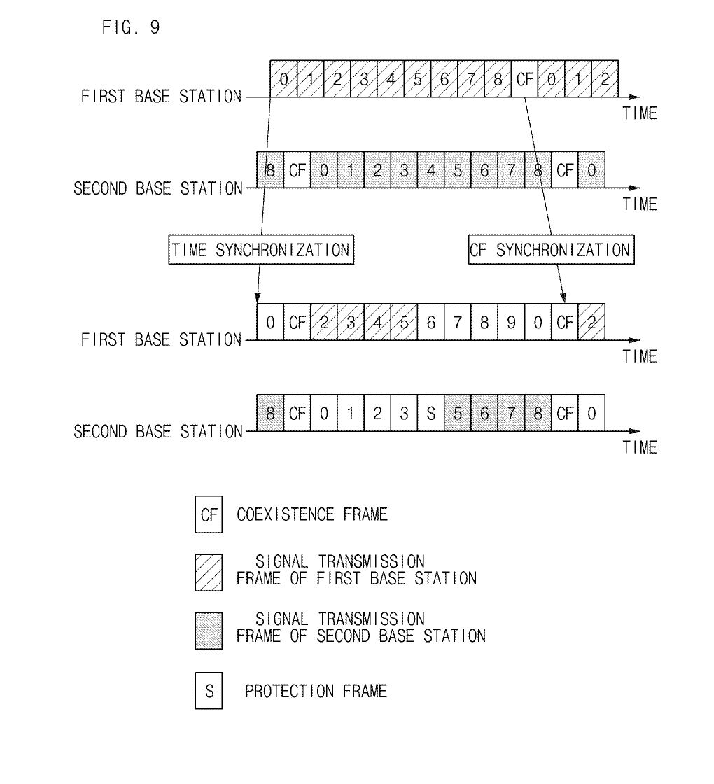

FIG. 7 is a flowchart illustrating a resource allocating method of a base station according to an exemplary embodiment of the present invention. FIG. 8 is a diagram for describing an operating method of a base station according to an exemplary embodiment of the present invention. FIG. 9 is a diagram for describing an operating method of a base station according to another exemplary embodiment of the present invention.

Referring to FIG. 7, the operating method may include receiving information on an existence signal of another base station or a coexistence frame in a transmission frame of another base station from a terminal (S210), making time synchronization with another base station and frame synchronization with the coexistence frame of another base station coincide with each other (S220), and allocating a signal transmission frame so as not to overlap the signal transmission frame in the transmission frame of another base station (S230).

Hereinafter, steps S210 and S220 described above will be described in more detail with reference to FIGS. 8 and 9.

First, referring to FIG. 8, the base station 200 (see FIG. 2) may receive information on the existence signal of another base station (for example, the first base station 100) or the coexistence frame in the transmission frame of another base station from the terminal 300 (S210). The existence signal may be generated by using a Zadoff-Chu sequence. The base station 200 may receive the existence signal from the terminal 300 through the common frequency band. The transmission frame may include the coexistence frame and a plurality of signal transmission frames. For example, the coexistence frame may be appreciated as a frame where neither the base station nor another base station 100 transmits signals.

The base station 200 may make the time synchronization with another base station 100 and the frame synchronization with the coexistence frame of another base station 100 coincide with each other (S220). For example, the base station 200 may make time synchronization of a transmission frame where signal transmissions starts coincide with another base station 100. When the base station 200 receives the existence signal of another base station 100 from the terminal 300, the base station 200 may determine the coexistence frame of another base station 100 by analyzing the existence signal and make the time synchronization with another base station 100 and the frame synchronization with the coexistence frame coincide with each other based on the determination result.

When the coexistence frames do not coincide with each other, different base stations (that is, base stations of different mobile communication operators) may alternately transmit the signals and an opportunity to transmit the signal is not given to another electronic apparatus (for example, wireless LAN) in the unlicensed band, and as a result, the wireless LAN system may transmit no signal while mobile communication systems operate. Therefore, the base station 200 makes the frame synchronizations of the coexistence frames coincide with each other to protect even a communication function of another electronic apparatus (for example, wireless LAN apparatus).

The base station 200 may allocate the signal transmission frame so as not to overlap with the signal transmission frame in the transmission frame of another base station 100 (S230). In detail, the base station 200 may allocate the signal transmission frame to the transmission frame after the signal transmission frame of another base station 100 or allocate the signal transmission frame to the transmission frame before the signal transmission frame of another base station 100. For example, the signal transmission frame of the base station 200 may be longer or shorter than the signal transmission frame of another base station 100.

Referring to FIG. 9, the base station 200 may allocate the signal transmission frame to the signal transmission frame of another base station 100 and the transmission frame after the protection frame. That is, the transmission frame of the base station 200 may include the coexistence frame, the plurality of signal transmission frames, and the protection frame. For example, the signal transmission frame of the base station 200 may be the same as the signal transmission frame of another base station 100.

As described above, in the resource allocating method of the base station according to the exemplary embodiment of the present invention, the base station that recognizes the existence of another base station allocates the signal transmission frame so as not to overlap with the signal transmission frame of another base station to remove a collision and/or interference between the base station and another base station when multiple base stations (for example, base stations of different mobile communication operators) exist in the unlicensed band.

The above description just illustrates the technical spirit of the present invention and various modifications and transformations can be made by those skilled in the art without departing from an essential characteristic of the present invention.

Therefore, the exemplary embodiments disclosed in the present invention are used to not limit but describe the technical spirit of the present invention and the scope of the technical spirit of the present invention is not limited by the exemplary embodiments. The scope of the present invention should be interpreted by the appended claims and it should be analyzed that all technical spirits in the equivalent range are intended to be embraced by the present invention.

What is claimed is:

1. A resource allocating method of a base station, the method comprising:
receiving information on an existence signal of another base station or a coexistence frame in a transmission frame of the another base station from a terminal;
making time synchronization with the another base station and frame synchronization with the coexistence frame of the another base station coincide with each other; and
allocating a signal transmission frame so as not to overlap with a signal transmission frame in the transmission frame of the another base station.

2. The method of claim 1, wherein the existence signal is generated by using a Zadoff-Chu sequence.

3. The method of claim 1, wherein in the receiving of the information on the existence signal of the another base station or the coexistence frame in the transmission frame of the another base station from the terminal, the existence signal is received from the terminal through a common frequency band.

4. The method of claim 1, wherein the transmission frame includes the coexistence frame and a plurality of signal transmission frames.

5. The method of claim 4, wherein in the allocating of the signal transmission frame so as not to overlap with the signal transmission frame in the transmission frame of the another base station, the signal transmission frame is allocated to the transmission frame after the signal transmission frame of the another base station.

6. The method of claim 4, wherein the transmission frame further includes a protection frame defined in the transmission frame after the signal transmission frame of the another base station.

7. The method of claim 6, wherein in the allocating of the signal transmission frame so as not to overlap with the signal transmission frame in the transmission frame of the another base station, the signal transmission frame is allocated to the signal transmission frame of the another base station and the transmission frame after the protection frame.

8. A terminal comprising:
a receiving unit receiving a first existence signal from a first base station through a common frequency band; and
a transmitting unit transferring the first existence signal to a second base station through the common frequency band.

9. The terminal of claim 8, wherein the first existence signal is generated by using a Zadoff-Chu sequence.

10. The terminal of claim 8, wherein the receiving unit receives a second existence signal from the second base station through the common frequency band.

11. The terminal of claim 10, further comprising:
a determination unit determining whether the first base station exists by using the first existence signal and determining whether the second base station exists by using the second existence signal.

12. The terminal of claim 10, further comprising:
an analysis unit determining a first coexistence frame by analyzing the first existence signal and determining a second coexistence frame by analyzing the second existence signal.

13. The terminal of claim 12, wherein the transmitting unit transfers information on the first coexistence frame to the second base station.

14. The terminal of claim 8, wherein the first base station and the second base station are operated by different mobile communication operators.

15. An operating method of a terminal, comprising:
receiving a first existence signal from a first base station through a common frequency band; and
transferring the first existence signal to a second base station through the common frequency band.

16. The operating method of claim 15, wherein the first existence signal is generated by using a Zadoff-Chu sequence.

17. The operating method of claim 15, further comprising:
receiving a second existence signal from the second base station; and
determining a first coexistence frame by analyzing the first existence signal and determining a second coexistence frame by analyzing the second existence signal.

18. The operating method of claim 17, further comprising:
transferring information on the first coexistence frame to the second base station.
